(19) United States
(12) Patent Application Publication
(10) Pub. No.: US 2017/0024118 A1
(43) Pub. Date: Jan. 26, 2017

(54) Three-Part Gesture

(71) Applicant: HEWLETT-PACKARD DEVELOPMENT COMPANY, L.P., Houston, TX (US)

(72) Inventor: MARK MUNDY, HOUSTON, TX (US)

(21) Appl. No.: 15/112,511

(22) PCT Filed: Mar. 31, 2014
(86) PCT No.: PCT/US2014/032423

§ 371 Date: Jul. 19, 2016

(51) Int. Cl. G06F 3/0488; G06F 3/0484

(52) U.S. Cl. CPC G06F 3/04883; G06F 3/04845; G06F 2203/04808

(57) ABSTRACT

An example method is provided in according with one implementation of the present disclosure. The method includes displaying a first screen on a first display of an electronic device and a second screen on at least one second display connected to the electronic device. The method further includes identifying a three-pan gesture received on an input device and rotating a screen orientation of one of the first display or the second display, when the electronic device is connected to a second display, based on the gesture.

### BACKGROUND

Increasing number of today's users carry or operate one or more electronic devices that are equipped with a diverse set of functions. These devices can communicate with each other, reach the Internet, display different content (e.g. on embedded or external displays), perform various tasks, or access data services through networks. Various devices such as personal computers, all in one computing devices. Internet-enabled tablets, smart phones, laptops, televisions, and gaming consoles have become essential personal accessories, connecting users to friends, work, and entertainment. Users now have more choices and expect to efficiently connect different devices to display and access programs, data, and other content at all times.

### BRIEF DESCRIPTION OF THE DRAWINGS

FIG. 1 is a schematic illustration of an example of an electronic device for rotating the screen orientation of a display of the electronic device, rotating the screen orientation of at least one external display connected to the electronic device, and for changing the display mode of displays in accordance with an implementation of the present disclosure.

FIG. 2 illustrates a flow chart showing an example of a method for rotating the screen orientation of a display of an electronic device or for rotating the screen orientation of at least one external display connected to an electronic device in accordance with an implementation of the present disclosure.

FIGS. 3A and 3B illustrate examples of three-part gestures for rotating the screen orientation of a display in accordance with an implementation of the present disclosure.

FIGS. 4A and 4B illustrate alternative examples of three-part gestures for rotating the screen orientation of a display in accordance with an implementation of the present disclosure.

FIG. 5 illustrates a flow chart showing an example of a method for identifying a display which screen orientation is to be rotated in accordance with an implementation of the present disclosure.

FIG. 6 illustrates a flow chart showing an example of a method for changing the display mode of a display of an electronic device and at least one external display in accordance with an implementation of the present disclosure.

FIGS. 7A and 7B illustrate examples of gestures for changing the display mode of display of an electronic device and at least one external display in accordance with an implementation of the present disclosure.

FIG. 8 illustrates a flow chart showing an example of a method for simultaneously rotating the screen orientations of at least a plurality of identified displays in accordance with an implementation of the present disclosure.

### DETAILED DESCRIPTION OF SPECIFIC EXAMPLES

With the recent improvements in technology, electronic devices continue to play an increasing role in people's life. As used herein, the terms “electronic device” and “device” are to be used interchangeably and refer to any one of various smartphones, display screens, cellular telephones, tablets, personal data assistants (PDA's), laptops, computers, servers, and other similar electronic devices that include a processor and are capable of communicating with an input device (e.g., touch input device, touchless or proximity input device, etc.).

Different users rely on different type of electronic devices for many day-to-day activities and work related tasks. The large number of users that utilize different type of electronic devices stimulates providers to offer devices that can meet the increase in user demand, support the broad array of available services, and provide reliable communication.

Electronic devices come in different sizes, forms, and may include different technical features. Due to the proliferation of electronic devices, their technological capabilities and functions are continuously changing and increasing. Consequently, these devices also offer expanded services to their users. These electronic devices are often used to access the Internet, communicate with other devices, display different content, record audio and/or video, and perform other personal and business related functions.

Many of the electronic devices today may be portable or handheld devices. Unlike stationary computing devices that may have a fixed orientation of their displays (e.g., landscape orientation, portrait orientation, etc.), applications displayed on mobile or handheld computing devices can be viewed in either landscape or portrait mode. Most handheld electronic devices include hardware components (e.g., accelerometer, gyroscope, etc.) that recognize a request for change in orientation and adjust the screen of the mobile device accordingly. The available screen rotation on mobile devices allows users to view applications and content on these devices in different orientations and aspect ratios,

As used herein, the terms ‘display’ and ‘display device’ are to be used interchangeably and refer to an output device (i.e., the device hardware) for presentation of information in visual form. As used herein, the term “screen” refers to the displayed information or images produced on a display. As used herein, the term “screen orientation” refers to the orientation of the screen produced on the display (e.g., of an electronic device or an external display). For example, a display may show information in a landscape screen orientation or a portrait screen orientation.

In addition, many electronic devices may be controlled or operated via an input device (e.g., a touch display, a touch pad, a touchless or proximity device, etc.). In some examples, the input device is a hardware component used to provide data and control signals to an electronic device. A touch input device may be controlled by the user through input gestures by touching a portion of the input device with at least one finger. Some touch input devices may also detect objects such as a stylus or other suitable objects. A user can utilize the input device to control the operations of the electronic device, to respond to any displayed content (e.g., messages, emails, et.), and to control how the content is displayed on the screen (e.g., by zooming the text or image size). Alternatively, touchless or proximity input devices may include various electronic components (e.g., proximity sensors, cameras, etc.) that allow a user to control the operations of the electronic device through inputs (e.g., in the surface or space surrounding the device, etc.) without physically touching a portion of the input device (i.e., a screen or a touch pad) or the actual device. For example such inputs may be received in the space near, below, or above the device. Touchless or proximity input devices allow a user to provide input beyond the physical borders of the input device or the electronic device and on any surrounding surface to interact with the device,

While operating such electronic devices, it may be difficult for a user to change the screen orientation (e.g., from landscape orientation to portrait orientation) or the display mode of the display of the device or any external displays connected to the electronic device. For example, changing the screen orientation or the display mode of a display of the electronic device or external displays may involve using an input device (e.g., a mouse, a keyboard, etc.) to implement the necessary commands. However, using a mouse or a keyboard (i.e., external or internal to the device) may not always be convenient or efficient for a user (e.g., when the device is handheld, the keyboard takes lots of room on the display, etc.). For example, inputs which were originally designed for devices that use a keyboard or a mouse, may be very inconvenient and cumbersome for inputting or manipulating without using a keyboard or mouse.

As used herein, the term “display mode” refers to the position or the appearance of a screen on the display of an electronic device and on at least one external display connected to the electronic device. For example, the display mode may include a “clone mode”, where the display of the electronic device and at least one external display present the same screen. Also, the display mode may Include an “extended mode,” where a screen is displayed (or shared) on both the display of the electronic device and the at least one external display. Other display modes are also available.

It may also be difficult to connect electronic devices to external displays and to adjust the screen orientation of both, the display of the electronic device and the external display, when such connection exists. For example, an electronic device may be connected to an external display via a connection port on the device. When the electronic device is portable or handheld device, the connection port may be positioned on a specific portion of the device. Thus, if a user decides to change the screen orientation of the electronic device by physically rotating the device, the connection port may be positioned such that it may prevent the external display from being connected (e.g, the device may be rotated on a supporting stand and the access to the connection port may be blocked by the stand).

Further, there may be issues with changing the screen orientation of an electronic device connected to an external display. For example, when the electronic device is connected to an external display and a user decides to rotate the electronic device to change its screen orientation, the operating system (“OS”) of the electronic device may prevent the rotation of the screen of the device because it may not be able to control the orientation of the attached external display. Thus, even if an electronic device physically rotates, the screen orientation of the display may not change.

The present description is directed to devices, methods, and computer readable media for rotating the screen orientation of a display of an electronic device, rotating the screen orientation of external display(s) connected to an electronic device, and changing the display mode of such displays. Specifically, the present description proposes an approach for rotating the screen orientation of a display (e.g., a main display of an electronic device or an external display) by using a three-part gesture on an input device. Further, the approach proposes using a three-part gesture to change the display mode of the display of an electronic device and at least one external display connected to the electronic device.

In one example, to rotate the screen orientation of an external display, the approach may use two motionless inputs and a non-linear motion. As used herein, the term “input” refers to an actual contribution or an effort (e.g., touch input, touchless input) by a user provided on a portion or an area of an input device (touch input device, touchless or proximity input device). As used herein, the term “motion” refers to any movement or change in position of an input. In another example, to rotate the screen orientation of the display of the electronic device, the approach may use a three-part gesture that includes three motionless inputs followed by a three-part rotating motion. To change the display mode of a display of an electronic device and at least one external display, the proposed approach may use a gesture that includes two motionless inputs and a linear motion.

Thus, the proposed description enables accurate, effective and efficient rotation of the screen orientation of electronic devices and changing the display mode of an electronic device and at least one attached display. By using the proposed three-part gestures, users can select and/or change the orientation and the position of displays independently and quickly.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. Furthermore, the term based as used herein, means based at least in part on It should also be noted that a plurality of hardware and software based devices, as well as a plurality of different structural components may be used to implement the disclosed methods and devices.

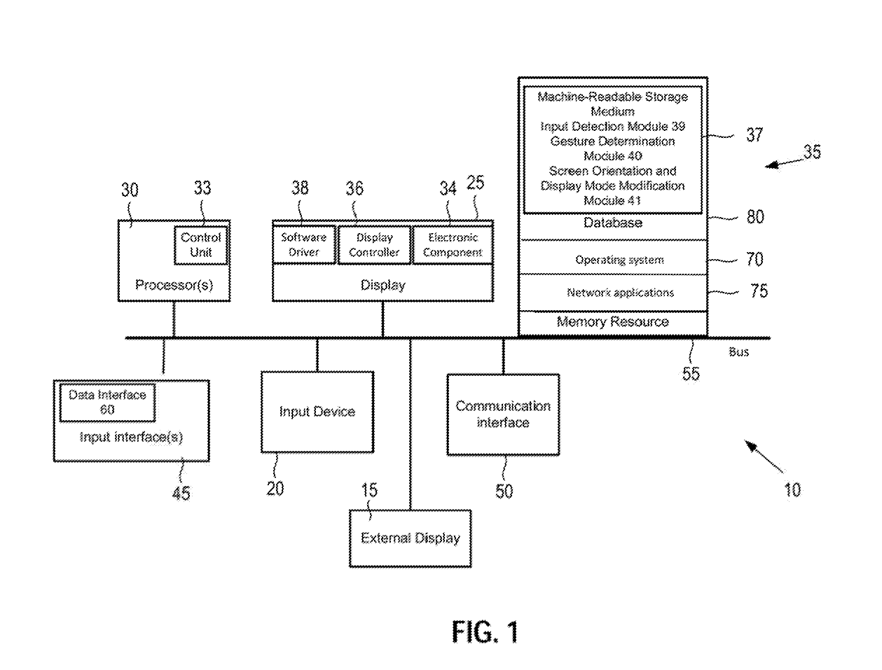

FIG. 1 is a schematic illustration an electronic device 10 for rotating the screen orientation of a display of the electronic device, rotating the screen orientation of at least one external display(s) connected to the electronic device, and changing the display mode of displays. The illustrated electronic device 10 is capable of carrying out the techniques described below. It is to be understood that the techniques described in relation to the device 10 may be implemented with any other electronic device. The electronic device 10 can be a tablet, a laptop, a personal computer, an all in one computing device, a gaming console, a server, a smartphone, a music player, a visual player, a personal digital assistant (PDA), a cellular telephone, an electronic notepad, a plurality of distributed computing devices, or any other suitable electronic device that includes a processor and is capable of displaying content on a display. In the illustrated example, the electronic device 10 may include an input device 20 (e.g., a touchscreen, a touch pad, a touchless or proximity device, etc.), at least one display 25 (that may operate as an input device), at least one processing device 30 (also called a processor), a memory resource 35, input interface(s) 45, and communication interface 50.

In other examples, the electronic device 10 includes additional, fewer, or different components for carrying out the functionality described herein. It is to be understood that the operations described as being performed by the electronic device 10 that are related to this description may, in some implementations, be performed or distributed between the electronic device 10 and other electronic/computing devices (not shown).

As explained in additional details below, the electronic device 10 includes software, hardware, or a suitable combination thereof configured to enable functionality of the electronic device 10 and to allow it to carry out the techniques described below and to interact with the one or more systems or devices. For example, the electronic device 10 includes communication interfaces (e.g., a Wi-Fi® interface, a Bluetooth® interface, a 3G interlace, a 4G interface, a near field communication (NFC) interface, etc.) that are used to connect with other devices/systems and/or to a network (not shown). The network may include any suitable type or configuration of network to allow for communication between the electronic device 10 and any other devices/systems (e.g., other electronic devices, computing devices, displays, etc.).

For example, the electronic device 10 can be connected with at least one external display 15. Alternatively, the device may be connected to a plurality of external displays (not shown). In one implementation, the electronic device 10 includes a communication port (not shown) that allows the external display 15 to connect to the electronic device 10.

The display 25 of the device 10 provides visual information to a user, such as various content, icons, tabs, video images, pictures, etc. The display 25 may also display content from different applications running on the electronic device 10 on a screen (not shown) on the display 25. The display 25 may be a transparent liquid crystal display (LCD), an organic light emitting diode (OLED) display, a plasma display, or any other suitable display. The display 25 may be part of the electronic device 10 (e.g., when the electronic device 10 is tablet or all in one device), may be a separated component that is in electronic communication with the electronic device 10 (e.g., when the electronic device is a desktop computer with a separate display), and may be a detachable component that may also be used as a handheld device (e.g., when the electronic device 10 is a convertible computing device).

The entire display 25 or at least a portion of the display 32 can be touch sensitive (i.e., the display is a touch display) for detecting input/contact from an object and for providing input to the electronic device 10. A touch display 25 may act as an input device 20 and may allow a user to use an object (e.g., a finger, stylus, etc.) to contact the upper surface of the display 15. The specific details of the input or touch (e.g., type of motion, location, pressure, duration, etc.) provide different information and/or commands to the electronic device 10 for processing.

In one example, the display 25 may include touch panel (not shown) that is positioned above a display panel (not shown). The electronic device 10 may also include at least one electronic component 34 (e.g., touch sensor, optical fiber component, etc.) or different combinations of electronic and/or hardware components 34 to identify the point of contact, and to scan and detect the fingers and/or the finger images of a user. In one implementation, the electronic components of the display 25 may include a plurality of sensors positioned on the touch panel that are in communication with the processor 30.

The display 25 may also include a screen controller 36 that processes the signals received from the touch panel and its electronic components 34 and translates these into touch event data (i.e., detected contact, location of contact, type of contact, etc.), which is passed to the processor 30 of the electronic device 10 (e.g., via the bus 55). The display may further include a software driver 38 that provides an interface to an operating system 70 of the device 10 and translates the touch event data into different events.

In one example, the input device 20 may operate similarly to the touch display 25 (e.g., may be a touch input device). In another example, the input device 20 may be a touchless or proximity input device that may allow a user to provide input through gestures or motions on a surface or the space surrounding the device 10 (e.g., in the space near, below, above the device 10, etc.) such that the input extends beyond the physical borders of the input device 20 or the electronic device 10. The input device 20 may be integrated into the electronic device 10 or may be an external input device in communication with the device 10. The touch display 25 or the input device 20 described herein are not intended to limit the means for receiving inputs to touch sensitive devices and are provided as an example. Therefore, any other suitable devices or means may be used to provide touch gesture input to the device 10 and to produce the functionality described below.

The processing device 30 of the electronic device 10 (e.g., a central processing unit, a group of distributed processors, a microprocessor, a microcontroller, an application-specific, integrated circuit (ASIC), a graphics processor, a multiprocessor, a virtual processor, a cloud processing system, or another suitable controller or programmable device), the memory resource 35, the input interfaces 45, and the communication interface 50 are operatively coupled to a bus 55.

The communication interface 50 allows the electronic device 10 to communicate with plurality of networks, communication links, and external devices. The input interfaces 45 can receive information from devices/systems in communication with the electronic device 10. In one example, the input interfaces 45 include at least a data interface 60 that may receive data from any external device or system.

The processor 30 includes a controller 33 (also called a control unit) and may be implemented using any suitable type of processing system where at least one processor executes computer-readable instructions stored in the memory 35. The processor 30 may independently control the display 25, the external display 15, and any other external display. The processor 30 may receive input from the input device 20, the display 25, or any other input device in communication with the device 10.

The memory resource 35 includes any suitable type, number, and configuration of volatile or non-transitory machine-readable storage media 37 to store instructions and data Examples of machine-readable storage media 37 in the memory 35 include read-only memory (“ROM”), random access memory (“RAM”) (e,g., dynamic RAM [“DRAM”], synchronous DRAM [“SDRAM”], etc.), electrically erasable programmable read-only memory (“EEPROM”), flash memory, an SD card, and other suitable magnetic, optical, physical, or electronic memory devices. The memory resource 35 may also be used for storing temporary variables or other intermediate information during execution of instructions to by the processor 30.

The memory 35 may also store an operating system 70 and network applications 75. The operating system 70 can be multi-user, multiprocessing, multitasking, multithreading, and real-time. The operating system 70 can also perform basic tasks such as recognizing input from input devices: sending output to a projector and a camera; keeping track of files and directories on memory 35; controlling peripheral devices, such as printers, image capture device; and managing traffic on the bus 55. The network applications 75 include various components for establishing and maintaining network connections, such as computer-readable instructions for implementing communication protocols.

Software stored on the non-transitory machine-readable storage media 37 and executed by the processor 30 includes, for example, firmware, applications, program data, filters, rules, program modules, and other executable instructions. The control unit 33 retrieves from the machine-readable storage media 37 and executes, among other things, instructions related to the control processes and methods described herein. In one example, the instructions stored in the non-transitory machine-readable storage media 37 implement a input detection module 39, a gesture determination module 40, and a screen orientation and display mode modification module 41. In other examples, the instructions can implement more or fewer modules (e.g., venous other modules related to the operation of the device 10). In one example, modules 39-41 may be implemented with electronic circuitry used to carry out the functionality described below. As mentioned above, in addition or as an alternative, modules 39-41 may be implemented as a series of instructions encoded on a machine-readable storage medium and executable by a processor.

As explained in additional detail below, the input detection module 39 detects inputs (e.g., touches, motions) received on an input device (the device 20, the display 25, etc.) in communication with the electronic device 10. The gesture determination module 40 identifies a three-part gesture from the inputs received on the input device. The screen orientation and display mode modification module 41 rotates the screen orientation of the display 25 and the external display 15, and changes the display mode of at least displays 15 and 25 based on the three-part gesture. In some example, to change the screen orientation of the display of the electronic device, the modules 40 and 41 may identify and use a three-part gesture that includes three motionless inputs followed by a three-part rotating motion. To change the display mode of a display of an electronic device and at least one external display, the modules 40 and 41 may identify and use a gesture that includes two motionless inputs and a linear motion.

The memory 35 may include at least one database 80. In other example implementations, the device 10 may access external database (not shown) that may be stored remotely of the electronic device 10 (e.g., can be accessed via a network or a cloud). The database 80 or the external database 20 may store various information related to gestures that may control the operation of the device 10.

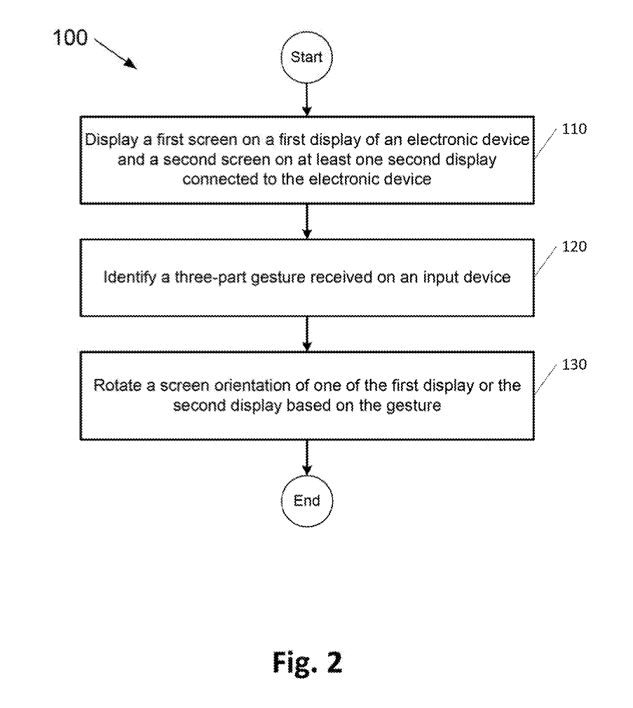

FIG. 2 illustrates a flow chart showing an example of a method 100 for rotating the screen orientation of a display of an electronic device or for rotating the screen orientation of at least one external display connected to an electronic device. In one example, the method 100 can be executed by the control unit 33 of the processor 30 of the electronic device 10. Various elements or blocks described herein with respect to the method 100 are capable of being executed simultaneously, in parallel, or in an order that differs from the illustrated serial manner of execution. The method 100 is also capable of being executed using additional or fewer elements than are shown in the illustrated examples.

The method 100 may be executed in the form of instructions encoded on a non-transitory machine-readable storage medium 37 executable by the processor 30 of the electronic device 10. In one example, the instructions for the method 100 implement the input detection module 39, the gesture determination module 40, and the screen orientation and display mode modification module 41. In other examples, the execution of the method 100 may be distributed between the processing device 30 and other processing devices in communication with the processing device 30. In yet another example, the method 100 may be executed on a separate device connected to the electronic device 10.

The method 100 begins at block 110, where the processor 30 displays a first screen (not shown) on the display 25 of the electronic device 10 and a second screen (not shown) on at least one external display 15 connected to the electronic device 10. The screens displayed on displays 20 and 25 may or may not be the same. As noted above, the term “screen” refers to the displayed information or images produced on a display. Thus, the display 25 may display a webpage and the display 15 may display a text document.

Next, the control unit 33 identifies a three-part gesture received on an input device (at 120). This may be performed by the input detection module 39 and the gesture determination module 40. A gesture may include a movement of at least one part of a body or a combination of body parts (e.g., a hand, etc.). The three-part gesture may include three separate but simultaneous in some examples) elements (e.g., touches or motions) and may be performed with three separate fingers (or other objects). The input device may be in communication with the electronic device 10. As noted above, the input device may be the device 20, the touch display 25, or any other suitable input device. As explained in additional details below, the control unit 33 identifies the type of three-part gesture received on the input device and based on the type of gesture proceeds to block 130.

At 130, the control unit 33 rotates the screen orientation of one of the display 25 or the at least one external display 15, when the electronic device 10 is connected to an external display, based on the three-part gesture. In other words, the control unit 33 may change the screen orientation the display 25 from a first screen orientation (e.g., landscape orientation) to a second screen orientation (e.g., a portrait orientation). When the device 10 is connected to an external display, the control unit 33 may change the screen orientation one of displays 25 or 15. This may be performed by the screen orientation and display mode modification module 41. As explained in additional details below, the three-part gestures for rotating the screen orientation of the display 25 and of the at least one external display 15 may be different.

In one example, the three-part gesture received on the input device may include two motionless inputs and a non-linear motion to rotate the screen orientation of the at least one external display 15. In another example, the gesture may include two motion inputs and a non-linear motion. As explained below, the described gesture may rotate the screen ordination of other external displays connected to the electronic device 10. In one example implementation, the screen controller 36 of the display 25 processes signals (i.e., the inputs) received from the touch display and translates these signals into touch event data which is passed to the software driver 38 of the electronic device 10. The software driver 38 communicates with the processor 30 which provides commands to the operating system 70 of the device 10 that translates the input touches to events (e.g., rotate screen, change display mode, etc.).

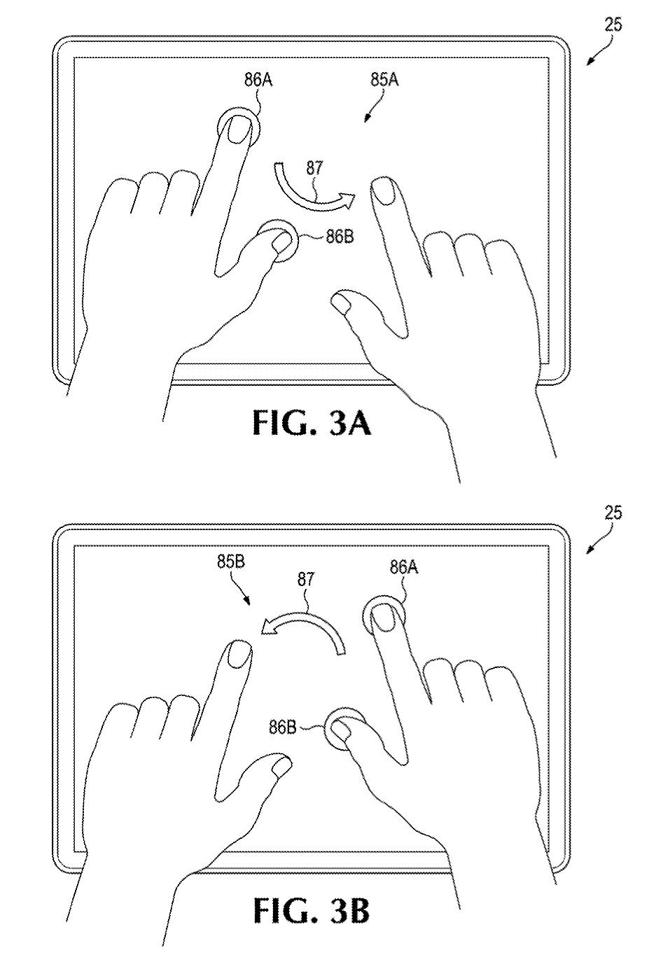

FIGS. 3A and 36 illustrate examples of three-part gestures 85A-B for rotating the screen orientation of a display. FIGS. 3A and 36 show two motionless inputs 86A-6 and a non-linear motion 87. The two motionless inputs may be simultaneous inputs or consecutive inputs. In the illustrated example, the two motionless inputs 86A-6 are performed with the index finger and the thumb of one hand and the non-linear motion 87 is performed with the index finger of the other hand of the user. Alternatively, these inputs may be performed with different fingers or with a tool (e.g., a stylus). The two motionless inputs may be positioned at different orientations on the input device (e.g., horizontal orientation, vertical orientation). For instance, the two motionless inputs may be in close proximity to each other. In one example implementation, the non-linear motion 87 may be received after the two motionless inputs. In another example implementation, the non-linear motion may be received at the same time as the two motionless inputs. The two motionless inputs may be a tap, a press, or any other suitable types of motionless input. The non-linear motion may be an “arch” motion a curved swipe motion, an “arc” motion, or any other type of non-linear motion.

Alternatively, the two inputs 86A-6 may be motion inputs. For instance, a pinch or a grasping motion may be used as an example of the two motion inputs 86A-B.

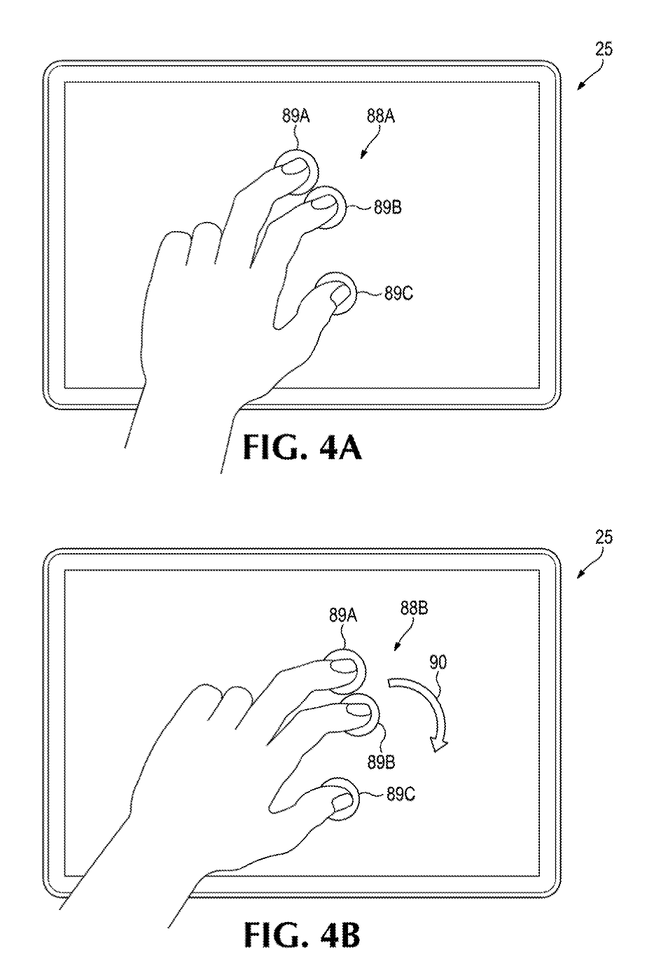

In another example, the three-part gesture received on the input device may include three motionless inputs followed by a three-part rotating motion to rotate the screen orientation of the display 25 of the device 10. The three-part rotating motion may be similar to the motion of rotating a key lock on a safe deposit box. FIGS. 4A and 46 illustrate alternative examples of three-part gestures 88A-6 for rotating the screen orientation of a display. FIGS. 4A and 46 show the three motionless inputs 89A-C followed by a three-part rotating motion 90. The three motionless inputs may be simultaneous inputs or consecutive inputs. In the illustrated example, the motionless inputs 89A-C are performed with the index finger, the thumb, and the middle finger of the user's hand. Alternatively, these inputs may be performed with different fingers or with another tool (e.g., a stylus). When the input device 20 is a touchless or proximity device, the three-part gesture may include pinching three fingers together before or during the rotation as well as closing the entire hand of the user before or during the rotation. It is to be understood that in other example implementations the gesture of FIGS. 4A and 4B used to rotate the screen orientation of the display 25 may be used to the rotate the screen orientation of external displays. Further, the gesture of FIGS. 3A and 3B used to rotate the screen orientation of the external display 15 may be used to the rotate the screen orientation of the display 25.

With continued reference to FIGS. 4A and 4B, the three-part gesture may be received at any portion area of the input device. The specific direction of the three-part rotating motion 90 may determine the direction of the screen rotation. In other words, if the three-part rotating motion 90 is in a clockwise direction in relation to the display 25, the control unit may rotate the screen orientation of the display 25 clockwise. The screen orientation of the display 25 may be rotated in increments, where each three-part rotating motion may rotate the screen of the display by 90 degrees or another predefined increment.

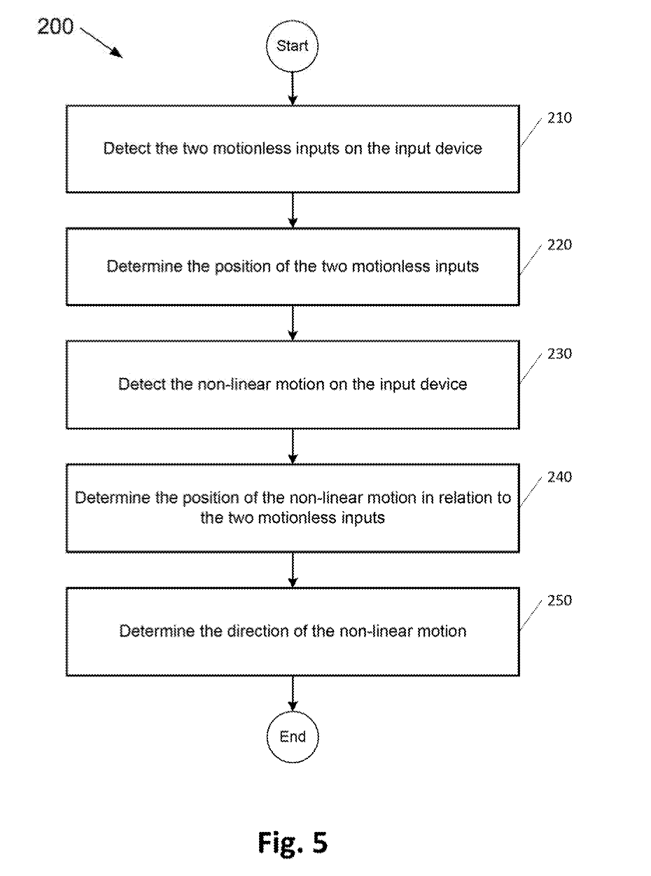

FIG. 5 illustrates a flow chart showing an example of a method 200 for identifying a display which screen orientation is to be rotated. This method may relate to the rotation of screen orientation of displays that are external to the electronic device 10 (as shown in FIGS. 3A and 3B). In some examples, the electronic device 10 may be connected to a plurality of external displays (e.g., located to the right/left of the device 10, above/below the device 10, etc.). In one example, the method 200 can be executed by the control unit 33 of the processor 30 of the electronic device 10. The method 200 may be executed in the form of instructions encoded on a non-transitory machine-readable storage medium 37 executable by the processor 30 of the electronic device 10.

The method 200 begins at block 210, where the processor 30 detects the two motionless inputs 88A-B on the input device 20. The two motionless inputs may be simultaneous inputs or consecutive inputs. At 220, the control unit 33 determines the position of the two motionless inputs 86A-B (e.g., by using at least one electronic component 34). Next, the control unit detects the non-linear motion 87 on the input device (at 230). At 240, the control unit 33 determines the position of the non-linear motion 87 in relation to the two motionless inputs 86A-B. Then, the control unit determines the direction of the non-linear motion 87 (at 250).

Based on process described in FIG. 5, the control unit 33 determines the external display which screen orientation is to be rotated. When the non-linear motion is on the right of the two motionless inputs (as shown in FIG. 3A), the control unit 33 may rotate the screen orientation of an external display 15 positioned on the right of the display 25 of the device 10. When the non-linear motion is on the left of the two motionless inputs (as shown in FIG. 36), the control unit 33 may rotate the screen orientation of an external display 15 positioned on the left of the display 25.

When the non-linear motion is below the two motionless inputs, the control unit may rotate the screen orientation of an external display 15 positioned below the display 25. When the non-linear motion is above the two motionless inputs, the control unit 33 may rotate the screen orientation of an external display 15 positioned above the display 25. In addition, the direction of the non-linear motion may determine the direction of screen rotation on the display 25. For example, if the non-linear motion is in a counter-clockwise direction in relation to the display 25, the control unit 33 may rotate the screen orientation of the external display 15 counter-clockwise. Alternatively, if the non-linear motion is in a clockwise direction in relation to the display 25, the control unit 33 may rotate the screen orientation of the external display 15 clockwise. The screen orientation of the display 15 may be rotated in increments, where each non-linear motion may rotate the screen of the display by 90 degrees or another predefined increment.

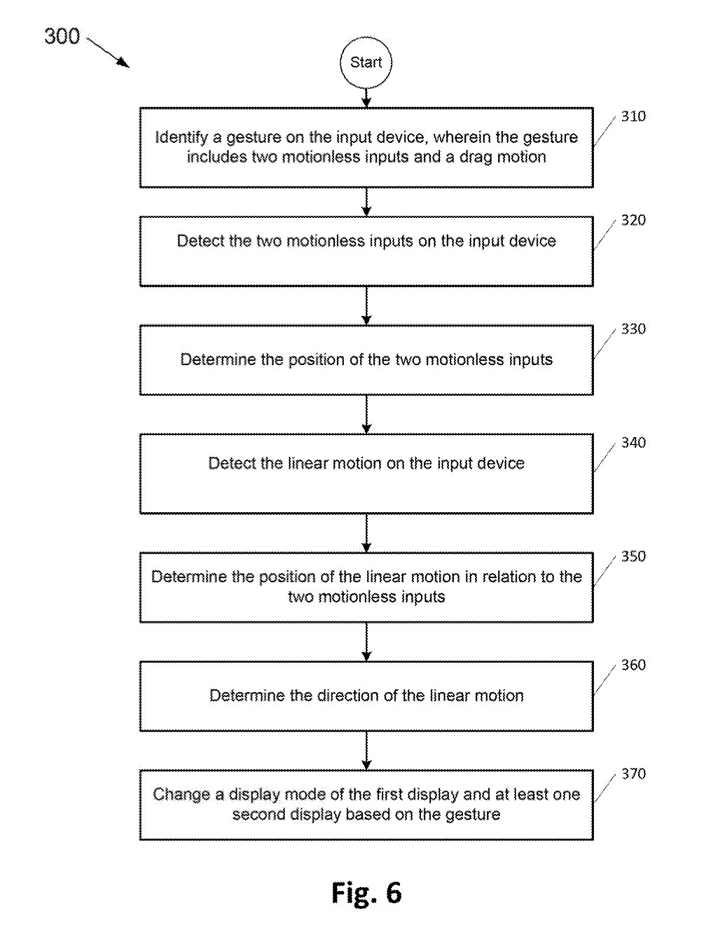

FIG. 6 illustrates a flow chart showing an example of a method 300 for changing the display mode of display of an electronic device and at least one external display. In one example, the method 300 can be executed by the electronic device 10. The method 300 may be executed with the input detection module 39, the gesture determination module 40, and the screen orientation and display mode modification module 41, where these modules are implemented with electronic circuitry used to carry out the functionality described below. Various elements or blocks described herein with respect to the method 300 are capable of being executed simultaneously, in parallel, or in an order that differs from the illustrated serial manner of execution. It is to be understood that the method 300 may be implemented by the electronic device 10 or any other electronic device.

The method 300 begins at 310, where the electronic device 10 identifies a gesture on an input device (e.g., the device 25, the display 25, etc.). In one example, the gesture includes two motionless inputs and a linear motion. In another example, the two inputs may be motion inputs. For instance, a pinch or a grasping motion may be used as an example of the two motion inputs,

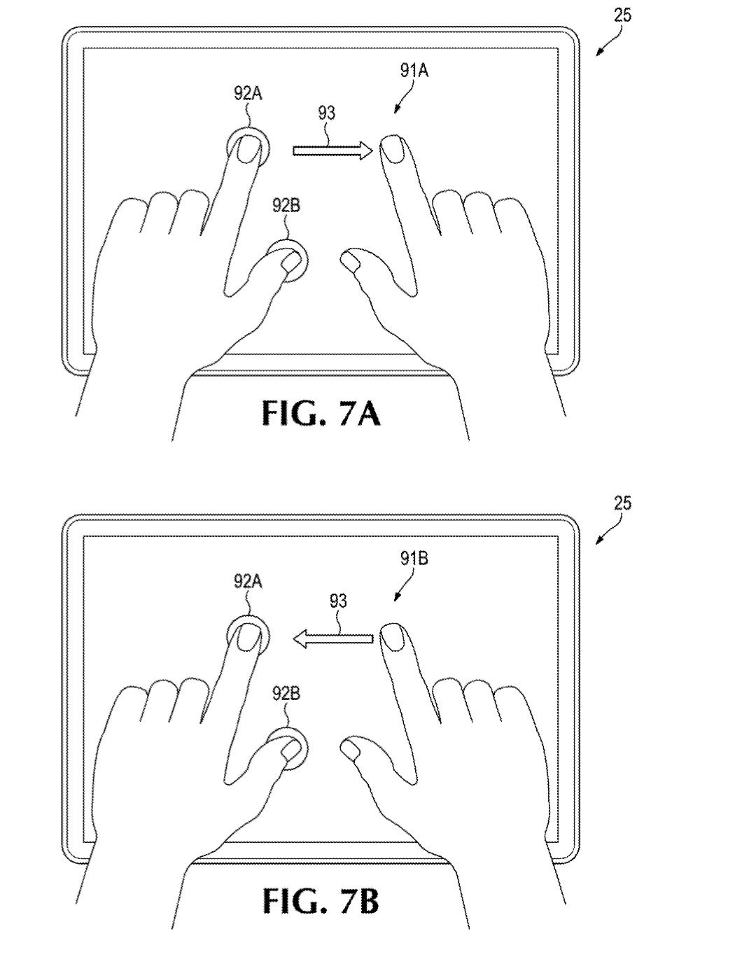

FIGS. 7A and 7B illustrate examples of gestures 91A-B for changing the display mode of a display of an electronic device and at least one external display. In the illustrated example, the two motionless inputs 92A-B are performed with the index finger and the thumb of one hand and the linear motion 93 is performed with the index finger of the other hand of the user. Alternatively, these inputs or motions may be performed with different fingers or with a tool (e.g, a stylus). The two motionless inputs may be simultaneous inputs or consecutive inputs. In one example implementation, the linear motion 93 may be received after the two motionless inputs. In another example implementation, the linear motion 93 may be received at the same time as the two motionless inputs. The linear motion 93 93 may include a drag, a linear swipe, or any other type of linear motion.

At 320, the electronic device 10 detects the two motionless inputs 92A-B on the input device. Next, at 330, the device 10 determines the position of the two motionless inputs 92A-B (e.g,, by using at least one electronic component 34). The electronic device 10 then detects the linear motion 93 on the input device (at 340). At 350, the device 10 determines the position of the linear motion 93 in relation to the two motionless inputs 92A-B. Then, the device 10 determines the direction of the linear motion 93 (at 360).

At 370, the electronic device 10 changes the display mode of the display 25 and at least one external display 15, when the electronic device is connected to a second display, based on the gesture on the input device. As shown in FIG. 7A, when the electronic device determines that the linear motion is directed away from the two motionless inputs, the device may change the display mode of the display 25 display and the at least one external display 15 to an extended mode. Depending on position on the connected external displays, the position of the two motionless inputs, and the direction of the linear motion, the electronic device 10 may determine which external display is involved in the display mode change (when multiple external displays are connected to the device 10).

For example, when the linear motion is on the right and is directed away from the two motionless inputs (as shown in FIG. 7A), the device 10 may change the display mode of the displays 25 and 15 to an extended mode, where the primary display is on the left and the secondary display is on the right. Further, when the linear motion is on the left and is directed away from the two motionless inputs, the device 10 may change the display mode of the displays 25 and 15 to an extended mode, where the primary display is on the right and the secondary display is on the left. When the linear motion is above and is directed away from the two motionless inputs, the device 10 may change the display mode of the displays 25 and 15 to an extended mode, where the primary display is on the bottom and the secondary display is on the top. When the linear motion is below and is directed away from the two motionless inputs, the device 10 may change the display mode of the displays 25 and 15 to an extended mode, where the primary display is on the top and the secondary display is on the bottom.

Alternatively, when the electronic device 10 determines that the linear motion is directed towards the two motionless inputs, the device 10 may change the display mode of the display 25 display and the at least one external display 15 to a clone mode (as shown in FIG. 7B). In that situation, the position of the external display, the position of the two motionless inputs, and the direction of the linear motion may determine which external display is involved in the display mode change when multiple external displays are connected to the device 10).

For example, when the linear motion is on the right and is directed towards the two motionless inputs (as shown in FIG. 7B), the device 10 may change the display mode of the displays 25 and 15 to a clone mode, where the external display 15 is the right of the display 25. Further, when the linear motion is on the left and is directed towards from the two motionless inputs, the device 10 may change the display mode of the displays 25 and 15 to a clone mode, where the external display 15 is the left of the display 25. When the linear motion is above and is directed towards the two motionless inputs, the device 10 may change the display mode of the displays 25 and 15 to a clone mode, where the external display 15 is above the display 25. When the linear motion is below and is directed towards the two motionless inputs, the device 10 may change the display mode of the displays 25 and 15 to a clone mode, where the external display 15 is the below the display 25.

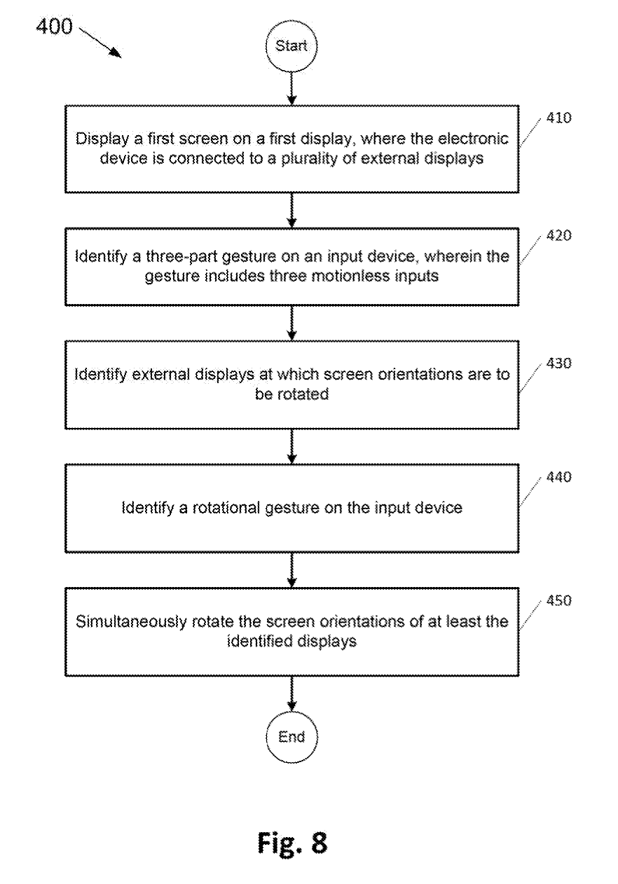

FIG. 8 illustrates a flow chart showing an example of a method 400 for simultaneously rotating the screen orientations of at least a plurality of identified displays. As rioted above, the electronic device 10 may be connected to a plurality of external displays. In one example, the method 400 can be executed by the control unit 33 of the processor 30 of the electronic device 10. The method 400 may be executed in the form of instructions encoded on a non transitory machine-readable storage medium 37 executable by the processor 30 of the electronic device 10. In one example, the instructions for the method 400 implement the input detection module 39, the gesture determination module 40, and the screen orientation and display mode modification module 41.

The method 400 begins at block 410, where the control unit 33 is to display a first screen on the display 25. The electronic device 10 may or may not be connected to any external displays (not shown). At 420, the control unit 33 is to identify a three-part gesture on an input device (e.g., device 20, display 25, etc.). In one example, the gesture includes three motionless inputs. The three motionless inputs may be simultaneous inputs or consecutive inputs. The inputs may be performed with the index finger, the thumb, and the middle finger of user's hand. Alternatively, the inputs may be performed with different fingers or with a tool (e.g., a stylus). The three motionless inputs may be a tap, a press, or any other suitable types of input. In other examples, the gesture may include different type or number of inputs.

At 430, the control unit 33 is to identify external displays which screen orientations are to be rotated, when the electronic device is connected to a plurality of external displays. In that situation, the electronic device 10 may be connected to a plurality of external displays (not shown). For instance, the three-part gesture on the input device may indicate to the control unit 33 that a use wishes to rotate the screen orientation of the display 25 and/or the displays connected to the device 10. In that case, identifying the three-part gesture by the control unit 33 may be followed by displaying a new message screen not shown) on the display 25, 15, or another external display. The message screen may provide information about the total number of displays connected to the device 10. For example, the message screen may graphically represent all displays connected to the device 10 according to their position in relation to the display 25.

All external displays connected to the device 10 may be respectively numbered in the message screen (e.g., 1 . . . n). In addition, the message screen may provide an option for selecting the displays that are to be rotated (e.g., by including a check box near all displays shown on the message screen, by highlighting the border of images representing all displays, etc.). That way, a user may select or identify the external displays which screen orientations are to be rotated. A user may select one or multiple external displays. The user may or may not select the display 25 of the device 10. In one example, the screen of the display 25 is automatically rotated when the screens of the selected external displays are rotated. In another example, only the screens of the selected external displays are rotated and the screen of the display 25 is not rotated unless specifically selected. In yet another example, only the screen of the display 25 may be rotated.

At 440, the control unit is to identify a rotational gesture on the input device. In one example, the rotational gesture is a non-linear motion following the three motionless inputs (e.g., similar to the non-linear motion shown in FIGS. 3A and 3B). The non-linear motion may be received after the three motionless inputs. In another example implementation, the non-linear motion may be received at the same time as the three motionless inputs. The direction of the non-linear motion may determine the direction of screen rotations on the selected displays. For example, if the non-linear motion is in a counter-clockwise direction in relation to the display 25, the control unit 33 may rotate the screen orientation of the external displays counter-clockwise. Alternatively, if the non-linear motion is in a clockwise direction in relation to the display 25, the control unit 33 may rotate the screen orientation of the external displays clockwise. The screen orientation of the selected displays may be rotated in increments, where each non-linear motion may rotate the screen of the display by 90 degrees or another predefined increment.

In another example, the rotation gesture is a three-part rotating motion with the fingers used for the three motionless inputs (e.g., similar to the rotating motion shown in FIGS. 4A and 4B). In one example, the three-part rotating motion performs a rotational movement on the input device. A user may use the same fingers used to perform the three motionless inputs to perform the rotation motion. In that situation, a user may or may not remove his or her hand from the input device (or from the surrounding space when the input device is a proximity device) after the initial three motionless inputs. As described above in relation to the three-part rotating motion of FIGS. 4A and 4B, the direction of the three-part rotating motion may determine the direction of screen rotations on the selected displays.

At 450, the control unit 33 is to simultaneously rotate the screen orientations of at least the identified displays. The screens of all selected displays may rotate in the same orientation. In other words, the screens of the external displays selected by the user are simultaneously rotated (e.g., from landscape to portrait orientation, etc.) based on the rotational gesture of the user. In another example implementation, the control unit 33 is to simultaneously rotate the screen orientation of the display 25 together with the screens of the external displays. Thus, in some situations the screens of the selected external displays and the display 25 may be rotated simultaneously and in the same direction without specifically selecting the display 25. Alternatively, a user may need to specifically select the display 25 in the message screen if he or she desires that the screen of that display 25 is rotated together with the screens of the external displays. In yet another alternative, only the screen of the display 25 may be selected and rotated.

What is claimed is:

1. A method, comprising:
displaying a first screen on a first display of an electronic device and a second screen on at least one second display connected to the electronic device;
identifying a three-part gesture received on an input device; and
rotating a screen orientation of one of the first display or the second display, when the electronic device is connected to a second display, based on the gesture.

2. The method of claim 1, wherein the three-part gesture includes two motionless inputs and a non-linear motion to rotate the screen orientation of the second display, wherein the non-linear motion is received after the two motionless inputs.

3. The method of claim 1, wherein the three-part gesture includes three motionless inputs followed by a three-part rotating motion to rotate the screen orientation of the first display.

4. The method of claim 2, further comprising
detecting the two motionless inputs on the input device:
determining a position of the two motionless inputs;
detecting the non-linear motion on the input device;
determining a position of the non-linear motion in relation he two motionless inputs; and
determining a direction of the non-linear motion.

5. The method of claim 4, further comprising rotating the screen orientation of the second display positioned on the right of the first display, when the non-linear motion is on the right of the two motionless inputs.

6. The method of claim 2, further comprising rotating the screen orientation of the second display positioned on the left of the first display, when the non-linear motion is on the left of the two motionless inputs.

7. The method of claim 2, further comprising rotating the screen orientation of the second display positioned below the first display, when the non-linear motion is below the two motionless inputs.

8. The method of claim 2, further comprising rotating the screen orientation of the second display positioned above the first display_{:} when the non-linear motion is above the two motionless inputs.

9. An electronic device comprising:
a first display to display a first screen;
an input device; and
at least one processing device with a control unit to:
identify a gesture on the input device, wherein the gesture includes two motionless inputs and a linear motion; and
change a display mode of the first display and at least one second, when the electronic device is connected to a second display, display based on the gesture.

10. The system of claim 9, wherein the control unit is further to:
detect the two motionless inputs on the input device;
determine a position of the two motionless inputs;
detect the linear motion on the input device;
determine a position of the linear motion in relation to the two motionless inputs; and
determine a direction of the linear motion.

11. The system of claim 10, wherein the control unit is further to:
change the display mode of the first display and the second display to an extended mode when the linear motion is directed away from the two motionless inputs.

12. The system of claim 8, wherein the control unit is further to:
change the display mode of the first display and the second display to a clone mode when the linear motion is directed towards the two motionless inputs.

13. A non-transitory machine-readable storage medium encoded with instructions executable by at least one processing device of an electronic device, the machine-readable storage medium comprising instructions to:
display a first screen on a first display;
identify a three-part gesture on an input device, wherein the gesture includes three motionless inputs;
identify external displays which screen orientations are to be rotated, when the electronic device is connected to a plurality of external displays,
identify a rotational gesture on the input device; and
simultaneously rotate the screen orientations of at least the identified displays.

14. The non-transitory machine-readable storage medium of claim 13, further comprising instructions to:
simultaneously rotate a screen orientation of the first display, wherein the rotational gesture is a non-linear motion following the three motionless inputs.

15. The non-transitory machine-readable storage medium of claim 13, wherein the rotation gesture is a three-part rotating motion with the fingers used for the three motionless inputs.
